(19) United States
(12) Patent Application Publication
(10) Pub. No.: US 2002/0194734 A1
(43) Pub. Date: Dec. 26, 2002

(54) Package unpacking hand tool

(76) Inventor: Harrison Huang, Taichung Hsien (TW)

Correspondence Address: BROWDY AND NEIMARK, P.L.L.C., 624 Ninth Street, N.W., Washington, DC, 20001-5303, US

(21) Appl. No.: 10/120,396

(22) Filed: Apr. 12, 2002

(30) Foreign Application Priority Data
Jun. 22, 2001 (TW) 90210732

(51) Int. Cl. B67B 7/00

(52) U.S. Cl. 30/2; 30/294

(57) ABSTRACT

A package unpacking hand tool includes a grip, a shaft axially slidably inserted through the grip, the shaft having an oblique top peak for hooking the packing plastic film of a package, and an oblique notch at the bottom side of the peak, a cutter blade supported on a spring inside the shaft and moved with the grip up and down across the oblique notch relative to the shaft to cut open the packing plastic film, a lever pivoted to the shaft, the lever having a protruded cutting portion for cutting adhesive tape, and an actuating member adapted to turn the lever in and out of the shaft between the operative position and the non-operative position.

### FIELD OF THE INVENTION

The present invention relates to hand tools and, more specifically, to a package unpacking hand tool adapted to cut off plastic packing film as well as adhesive tape from a packed carton or the like.

### BACKGROUND OF THE INVENTION

In factories or warehouses, workers usually use semi-transparent plastic packing film to pack stacked packages, so as to protect stacked packages against rainwater and dust and to keep stacked packages in place. A plastic packing film for this purpose is sticky. It is difficult to unpack a plastic packing film from stacked packages. FIG. 1 shows a package unpacking hand tool for this purpose. As illustrated, the package unpacking hand tool 90 comprises a handle 91, a peak 92 obliquely downwardly extended from the top end and adapted to pierce plastic packing film, a cutter blade 93 fixedly provide in a notch at the bottom side of the peak 92 and adapted to cut open plastic packing film, and a protruded metal blade 94 disposed at one side opposite to the peak 92 and adapted to cut adhesive tape from a carton. This structure of package unpacking hand tool 90 has numerous drawbacks as outlined hereinafter.

1. When hooking the peak 92 into the plastic packing film, the cutter blade 93 tends to be stuck in a tangled part of the plastic packing film, and the worker should employ more force to move the cutter blade 93 with the hand tool over the tangled part of the plastic packing film, or to change the hooking position of the peak 92 in the plastic packing film.

2. Because the metal blade 94 protrudes over one side of the handle 91, it may cut or hook the body or clothes of a person accidentally.

### SUMMARY OF THE INVENTION

The present invention has been accomplished to provide a package unpacking hand tool, which eliminates the aforesaid drawbacks.

It is one object of the present invention to provide a package unpacking hand tool, which enables the user to conveniently smoothly cut off the plastic packing film of packages with less effort.

It is another object of the present invention to provide a package unpacking hand tool, which is safe in use.

According to one embodiment of the present invention, the package unpacking hand tool comprises: an elongated grip for the holding of the hand, the grip comprising a receiving hole axially extended through top and bottom ends thereof and two pivot holes disposed near the top end and aligned at two sides of the receiving hole; a shaft inserted through the receiving hole of the grip for axial movement relative to the grip, the shaft comprising a top end extended out of the top end of the grip, a peak obliquely downwardly protruded from the top end at one side, a flat blade chamber disposed in the top end, an oblique notch disposed at a bottom side of the peak and partially cut into the flat blade chamber, an elongated rectangular spring chamber longitudinally downwardly extended from the flat blade chamber, and two longitudinal sliding slots respectively disposed in communication with the spring chamber at two opposite lateral sides between the pivot holes of the grip; a spring mounted in the spring chamber of the shaft, the spring having a bottom end stopped at a bottom side of the spring chamber and a top end facing the flat blade chamber; a cutter blade longitudinally slidably mounted in the flat blade chamber, the cutter blade having a protruded bottom mounting portion fastened to the top end of the spiral spring, a mounting through hole disposed adjacent to the protruded bottom mounting portion, and a cutting edge disposed across the oblique notch of the shaft; and a pin inserted through the pivot holes of the grip, the longitudinal sliding slots of the shaft, and the through hole of the cutter blade to secure the cutter blade to the grip. When the peak hooked in the plastic packing film, the cutter blade is moved axially with the grip relative to the shaft to cut open the plastic packing film.

According to another embodiment of the present invention, the package unpacking hand tool comprises a shaft, the shaft has an oblique top peak and a cutter blade disposed at the bottom side of the peak, a lever pivoted to an upright pivot rod in the top end of the shaft, the lever having a protruded cutting portion protruded from a top end thereof at one end corresponding to a side opening of the shaft for cutting adhesive tapes, and an actuating member mounted in an oblong slot of the shaft and adapted to turn the lever about the upright pivot rod between in and out of the side opening between the operative position and the non-operative position.

### BRIEF DESCRIPTION OF THE DRAWINGS

FIG. 1 is a perspective view of a package unpacking hand tool according to the prior art.

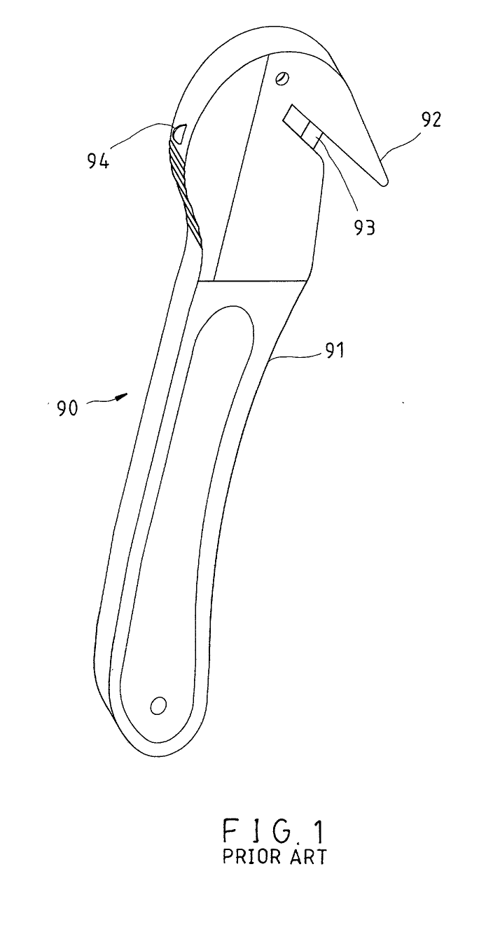

FIG. 2 is an exploded view of a first preferred embodiment of the present invention.

FIG. 3 is a front view of the first preferred embodiment of the present invention.

FIG. 4 is a rear side view of the first preferred embodiment of the present invention.

FIG. 5 is a sectional view of the first preferred embodiment of the present invention, showing the cutter blade and the grip moved to the upper limit position, and the actuating member moved to the first position.

FIG. 6 is similar to FIG. 5 but showing the cutter blade and the grip moved to the lower limit position, and the actuating member moved to the second position.

FIG. 7 is an exploded view of a second preferred embodiment of the present invention.

### DETAILED DESCRIPTION OF THEE INVENTION

Referring to FIGS. from 2 through 5, a package unpacking hand tool 10 is shown comprised of a grip 20, a shaft 30, a spiral spring 40, a cutter blade 50, a pin 60, a lever 70, and an actuating member 80.

The grip 20 is an elongated hollow shell convenient for the holding of one single hand, having a receiving hole 21 axially extended through top and bottom ends thereof and two pivot holes 22 respectively extended through the front and back sidewalls thereof and disposed at two sides of the receiving hole 21 near the front end.

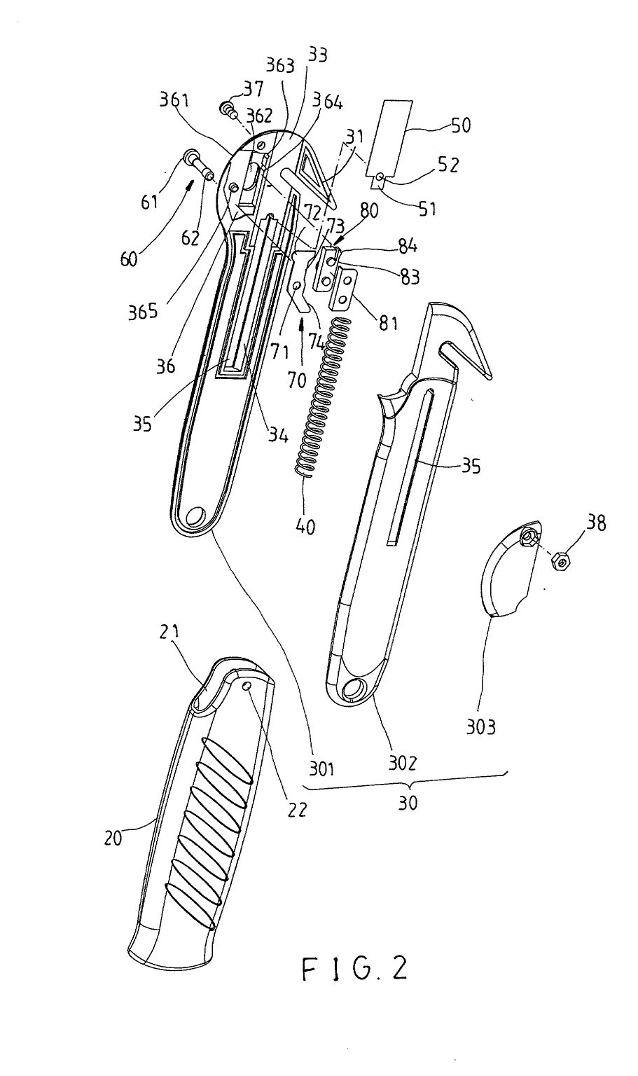

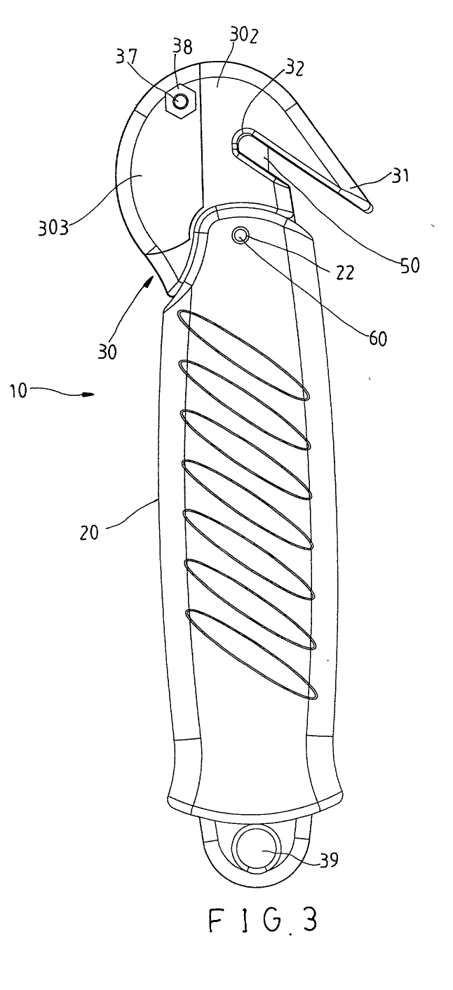

The shaft 30 is comprised of two elongated flat shaft elements, namely, the first shaft element 301 and the second shaft element 302 attached together, and a cover plate 303 fastened to the shaft elements 301 and 302 at the front side. The shaft 30 comprises a peak 31 obliquely downwardly protruded from the top end thereof at one side (the right side in FIG. 2), a flat blade chamber 33 disposed in the top end, an oblique notch 32 disposed at the bottom side of the peak 31 and partially cut into the flat blade chamber 33, a top opening 331 disposed in the top end at the top side of the flat blade chamber 33, an elongated rectangular spring chamber 34 longitudinally downwardly extended from the flat blade chamber 33, two longitudinal sliding slots 35 respectively disposed in the front and back sides thereof corresponding to the spring chamber 34, a recessed receiving space 36 defined in the top end of the first shaft element 301 at one lateral side of the flat blade chamber 33, a side opening 361 in the upper left corner of the recessed receiving space 36, an oblong slot 362 longitudinally disposed in the recessed receiving space 36 near the right side and pierced through the back side of the shaft 30, two recessed portions 363 and 364 disposed in the right side of the recessed receiving space 36 at different elevations, and an upright pivot rod 365 disposed in a middle part of the recessed receiving space 36. The second shaft element 302 fits over the first shaft element 301, having the upper left area notched so that the recessed receiving space 36 of the first shaft element 301 is seen after connection of the first shaft element 301 and the second shaft element 302. The cover plate 303 is covered on the recessed receiving space 36, and fixedly secured to the first shaft element 301 with a screw bolt 37 and a nut 38. The shaft 30 is inserted through the receiving hole 21 of the grip 20 such that the shaft 30 and the grip 20 can be moved axially relative to each other. FIG. 3 shows the shaft 30 moved relative to the grip 20 to the lower limit position (this will be described further) where the top end of the shaft 30 with the peak 31 and the oblique notch 32 are maintained protruded over the top side of the grip 20, and the bottom end of the shaft 30 is maintained protruded over the bottom side of the grip 20. Furthermore, the shaft 30 has a hanging hole 39 at the bottom end.

The spiral spring 40 is mounted in the spring chamber 34 of the shaft 30, having a bottom end stopped at the bottom side of the spring chamber 34 and a top end suspended in the top open side of the spring chamber 34 in the lower area of the flat blade chamber 33.

The cutter blade 50 is longitudinally slidably mounted in the flat blade chamber 33, having a protruded bottom mounting portion 51 fastened to the top end of the spiral spring 40 and a mounting through hole 52 disposed near the bottom side corresponding to the top end of the longitudinal sliding slots 35. The cutting edge of the cutter blade 50 is disposed at the right side across the oblique notch 32 of the shaft 30.

The pin 60 is inserted through the pivot holes 22 of the grip 20, the longitudinal sliding slots 35 of the shaft 30, and the through hole 52 of the cutter blade 50 to secure the cutter blade 50, the shaft 30, and the grip 20 together, having a head 61 and an expanded end block 62 disposed at two distal ends for positioning.

The lever 70 is a metal plate having a center pivot hole 71 coupled to the upright pivot rod 365 in the recessed receiving space 36 of the shaft 30 so that the lever 70 can be turned about the pivot rod 365 within the recessed receiving space 36, a protruded cutting portion 72 disposed at one side of the top end thereof corresponding to the side opening 361 of the shaft 30, and an inwardly curved right side formed of an oblique upper side edge 73 above the pivot rod 365 and an oblique lower side edge 74 below the pivot rod 365.

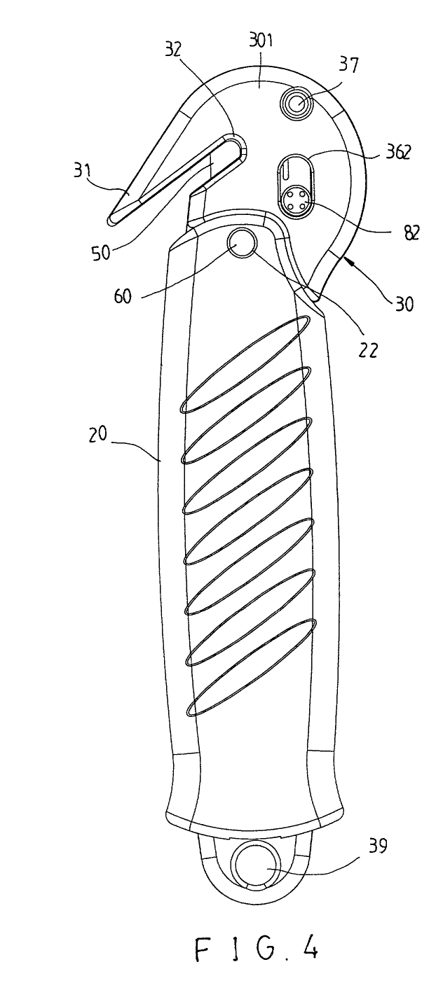

The actuating member 80 is a rectangular plastic block mounted in the recessed receiving space 36 at the right side with the left side edge thereof stopped against the inwardly curved right side of the lever 70. According to the present preferred embodiment, a metal guard plate 81 is fixedly covered on the actuating member 80 and disposed in contact with the lever 70. The actuating member 80 comprises a knob 82 disposed at the back side and inserted through the oblong slot 362 of the shaft 30 (see FIG. 4) for enabling the user to move the actuating member 80 longitudinally along the oblong slot 362, and a curved arm 83 disposed at the right side and terminating in a raised portion 84. When moving the actuating member 80 to the upper limit point (the top end of the oblong slot 362), the raised portion 84 is forced into engagement with the upper recessed portion 363, and therefore the actuating member 80 is positioned in the first position. On the contrary, when moving the actuating member 80 to the lower limit point (the bottom end of the oblong slot 362), the raised portion 84 is forced into engagement with the lower recessed portion 364, and therefore the actuating member 80 is positioned in the second position.

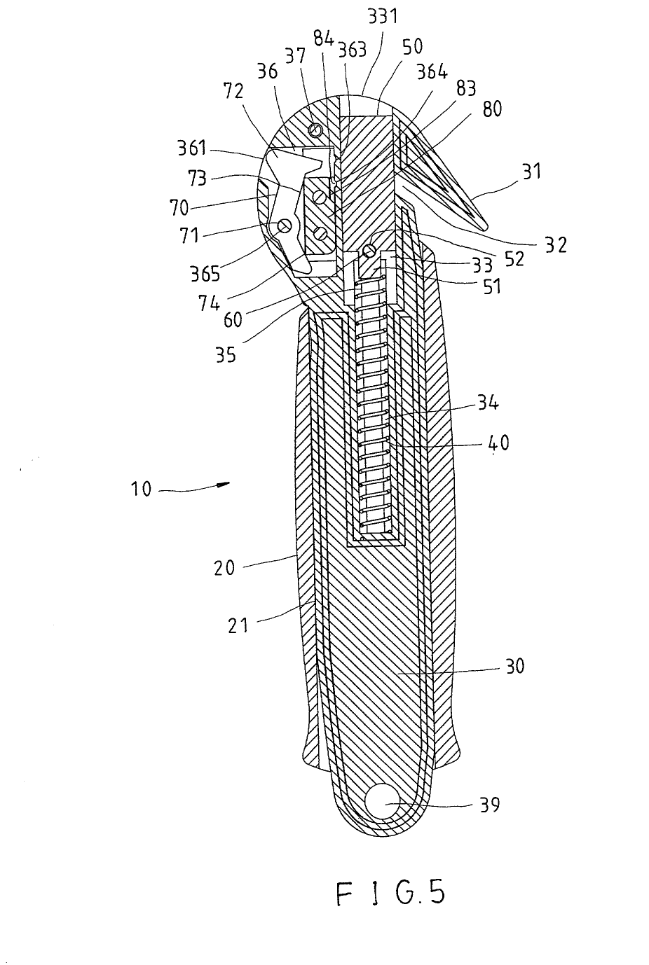

The operation of the hand tool 10 is outlined hereinafter. Normally, as shown in FIGS. 3 and 5, the cutter blade 50 and the grip 20 are forced upwards (relative to the shaft 20) by the spiral spring 40 to the upper limit position where the pin 60 is stopped at the top end of each longitudinal sliding slot 35. At this time, the shaft 30 is set in the lower limit position where the bottom end of the shaft 30 protrudes over the bottom side of the grip 20, and the bottom hanging hole 39 of the shaft 30 is exposed to the outside of the grip 20 for hanging on a tool rack or the like.

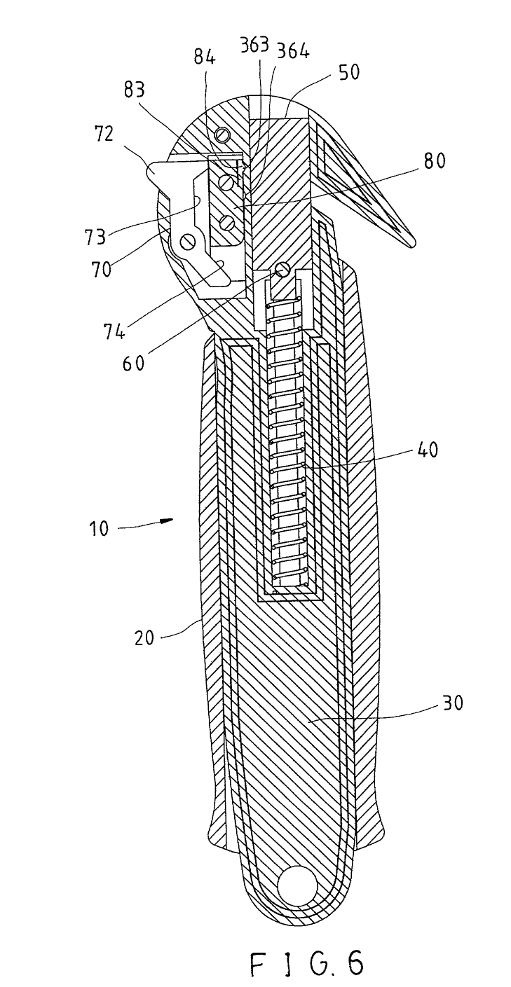

When using the hand tool 10 to cut off the plastic packing film of the package to be unpacked, hold the grip 20 with one hand, and then force the peak 31 of the shaft 30 through the plastic packing film, and then pull the hand tool 10 to cut open the plastic packing film with the cutter blade 50. The main feature of the present invention is that the peak 31 is used to pierce the plastic packing film, and then the grip 20 is pulled backwards to move the cutter blade 50 relative to the shaft 30 against the push force of the spiral spring 40 from the upper limit position to the lower limit position shown in FIG. 6 (where the bottom side of the cutter blade 50 is stopped at the bottom side of the flat blade chamber 33), i.e., the cutter blade 50 is moved relative to the shaft 30 to cut open the plastic packing film after the peak 31 of the shaft 30 hooked in the plastic packing film (this action is similar to the action of holding down a sheet of paper on a cutting pad at the top of a table with one hand and then cutting off the sheet of paper with a cutter by the other hand; the prior art method is similar to the action of directly use a cutter to cut off a sheet of paper on a cutting pad at the top of a table without holding down the sheet of paper with the hand). In case the cutter blade 50 is stuck in the tangled plastic packing film, the operator can release the pulling force and move the grip 20 forwards and then pull the grip 20 backwards again to reciprocate the cutter blade 50 against the tangled plastic packing film. Therefore, the hand tool 10 can cut off the plastic packing film with less effort.

The hand tool 10 can also be operated to cut off packing ropes or the like with the cutter blade 50 efficiently.

When the cutter blade 50 starts to wear or the cutting edge of the cutter blade 50 is damaged, the pin 60 is pulled away from the pivot holes 22 of the grip 20, the longitudinal sliding slots 35 of the shaft 30, and the through hole 52 of the cutter blade 50, and then the cutter blade 50 is pulled out of the flat blade chamber 33 through the top opening 331 for a replacement. After insertion of a new cutter blade into the flat blade chamber 33, the pin 60 is installed again to secure the new cutter blade to the grip 20.

The hand tool further provides another function of cutting off the adhesive tape on a packed carton. Referring to FIGS. 5 and 6, the user can move the actuating member 80 along the oblong slot 362. When moving the actuating member 80 to the first position (the upper limit position), as shown in FIG. 5, the upper left corner of the actuating member 80 is forced against the oblique upper side edge 73 of the lever 70, thereby causing the lever 70 to be turned about the upright pivot rod 365 in counter-clockwise direction. When turning the lever 70 about the upright pivot rod 365 in counter-clockwise direction, the protruded cutting portion 72 is moved out of the side opening 361 of the shaft 30 to cut off the adhesive tape from the packed carton. When not in use, the actuating member 80 is moved from the first position to the second position (the lower limit position), as shown in FIG. 6. When moving the actuating member 80 to the second position, the lower left corner of the actuating member 80 is forced against the oblique lower side edge 74 of the lever 70, thereby causing the lever 70 to be turned about the upright pivot rod 365 in clockwise direction, and therefore the protruded cutting portion 72 is received inside the side opening 361 of the shaft 30, preventing from cutting or hooking the body or clothes of a person accidentally.

If necessary, the cover plate 303 can be removed from the shaft element 301 so that the lever 70, the actuating member 80, or the metal guard plate 81 can be replaced, i.e., it is not necessary to detach the shaft 30 or the grip 20 when replacing the lever 70, the actuating member 80, or the metal guard plate 81.

Further, because the function of sliding the cutter blade 50 in the flat blade chamber 33 and the function of turning the lever 70 in and out of the side opening 361 are independently operated, they can separately employed to different unpacking tools.

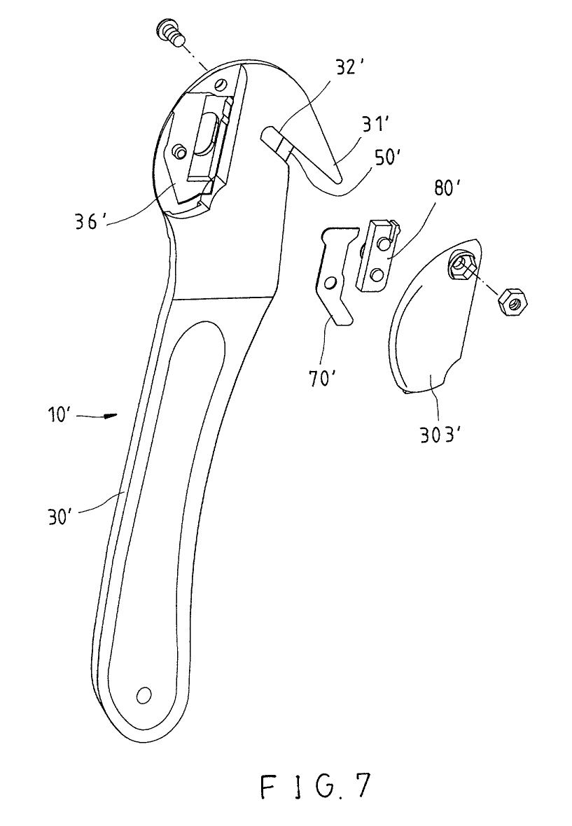

FIG. 7 shows a hand tool 10′ according to a second embodiment of the present invention. According to this embodiment, the hand tool 10′ comprises a shaft 30′. The shaft 30′ comprises a peak 31′ obliquely downwardly protruded from the top end at one side, an oblique notch 32′ disposed at the bottom side of the peak 31′, a cutter blade 50′ fixedly mounted on the inside and extended across the oblique notch 32′. The structure of the other side of the top end of the shaft 30′ is same as the aforesaid first embodiment, i.e., there is provided at the left side of the top end of the shaft 30′ a recessed receiving space 36′, a cover plate 303′ covered over the recessed receiving space 36′, a lever 70′ mounted in the recessed receiving space 36′, and an actuating member 80′ adapted to turn the lever 70′ in and out of the recessed receiving space 36′ of the shaft 30′.

What is claimed is:

1. A package unpacking hand tool comprising:
an elongated grip for the holding of the hand, said grip comprising a receiving hole axially extended through top and bottom ends thereof and two pivot holes disposed near the top end and aligned at two sides of said receiving hole;
a shaft inserted through the receiving hole of said grip for axial movement relative to said grip, said shaft comprising a top end extended out of the top end of said grip, a peak obliquely downwardly protruded from the top end at one side, a flat blade chamber disposed in the top end, an oblique notch disposed at a bottom side of said peak and partially cut into said flat blade chamber, an elongated rectangular spring chamber longitudinally downwardly extended from said flat blade chamber, and two longitudinal sliding slots respectively disposed in communication with said spring chamber at two opposite lateral sides between the pivot holes of said grip;
a spring mounted in said spring chamber of said shaft, said spring having a bottom end stopped at a bottom side of said spring chamber and a top end facing said flat blade chamber;
a cutter blade longitudinally slidably mounted in said flat blade chamber, said cutter blade having a protruded bottom mounting portion fastened to the top end of said spiral spring, a mounting through hole disposed adjacent to said protruded bottom mounting portion, and a cutting edge disposed across said oblique notch of said shaft; and
a pin inserted through the pivot holes of said grip, the longitudinal sliding slots of said shaft, and the through hole of said cutter blade to secure said cutter blade to said grip.

2. The package unpacking hand tool as claimed in claim 1 wherein said shaft further comprises a receiving space defined in the top end thereof at one lateral side of said flat blade chamber, a side opening in communication with said receiving space, and an oblong slot longitudinally disposed in said receiving space; a lever pivotally mounted in said receiving space, said lever having a protruded cutting portion; an actuating member mounted in said receiving space and extended out of the oblong slot of said shaft and adapted to turn said lever about said upright pivot rod between a first position where the protruded cutting portion of said lever is moved with said lever out of said side opening of said shaft, and a second position where the protruded cutting portion of said lever is received with said lever inside said receiving space, said actuating member having a knob disposed at one side thereof and extended out of said oblong slot of said shaft.

3. The package unpacking hand tool as claimed in claim 1 wherein said flat blade chamber extends to the topmost edge of the top end of said shaft; said pin is detachably mounted in the pivot holes of said grip, the longitudinal sliding slots of said shaft, and the through hole of said cutter blade.

4. The package unpacking hand tool as claimed in claim 1 wherein said cutter blade is moved in said flat blade chamber between an upper limit position where said pin is stopped at a top end of each of said longitudinal sliding slot, and a lower limit position where said cutter blade is stopped at the bottom side of said flat blade chamber.

5. A package unpacking hand tool comprising:
a shaft for the holding of the hand, said shaft having a top end, a peak obliquely downwardly protruded from the top end at one side, an oblique notch disposed at a bottom side of said peak, a receiving space defined in the top end, a side opening in communication with said receiving space, and an oblong slot longitudinally disposed in said receiving space and pierced through a back side thereof;
a cutter blade fixedly mounted in the top end of said shaft at an inner side of said oblique notch;
a lever pivotally mounted in said receiving space, said lever having a protruded cutting portion; and
an actuating member mounted in said receiving space and extended out of the oblong slot of said shaft and adapted to turn said lever between a first position where the protruded cutting portion of said lever is moved with said lever out of said side opening of said shaft, and a second position where the protruded cutting portion of said lever is received with said lever inside said receiving space.

6. The package unpacking hand tool as claimed in claim 2 wherein said lever has an inwardly curved side opposite to said side opening and formed of an oblique upper side edge above said upright pivot rod and an oblique lower side edge below said pivot rod; said actuating member is disposed in contact with the inwardly curved side of said lever, and moved in said oblong slot between an upper limit position where said actuating member is forced against the oblique upper side edge of said lever to turn said lever about said upright pivot rod to said first position where the protruded cutting portion of said lever is moved with said lever out of said side opening of said shaft, and a lower limit position where said actuating member is forced against the oblique lower side edge of said lever to turn said lever about said upright pivot rod to said second position where the protruded cutting portion of said lever is received with said lever inside said receiving space.

7. The package unpacking hand tool as claimed in claim 5 wherein said lever has an inwardly curved side opposite to said side opening and formed of an oblique upper side edge above said upright pivot rod and an oblique lower side edge below said pivot rod; said actuating member is disposed in contact with the inwardly curved side of said lever, and moved in said oblong slot between an upper limit position where said actuating member is forced against the oblique upper side edge of said lever to turn said lever about said upright pivot rod to said first position where the protruded cutting portion of said lever is moved with said lever out of said side opening of said shaft, and a lower limit position where said actuating member is forced against the oblique lower side edge of said lever to turn said lever about said upright pivot rod to said second position where the protruded cutting portion of said lever is received with said lever inside said receiving space.

8. The package unpacking hand tool as claimed in claim 2 wherein said shaft comprises an upper recessed portion and a lower recessed portion respectively disposed in said receiving space at different elevations; said actuating member comprises a curved arm, said curved arm having an outer end terminating in a raised portion, which is forced into engagement with said upper recessed portion when said actuating member moved said lever from said second position to said first position, or said lower recessed portion when said actuating member moved said lever to from said first position to said second position.

9. The package unpacking hand tool as claimed in claim 5 wherein said shaft comprises an upper recessed portion and a lower recessed portion respectively disposed in said receiving space at different elevations; said actuating member comprises a curved arm, said curved arm having an outer end terminating in a raised portion, which is forced into engagement with said upper recessed portion when said actuating member moved said lever from said second position to said first position, or said lower recessed portion when said actuating member moved said lever to from said first position to said second position.

10. The package unpacking hand tool as claimed in claim 8 wherein said lever is a metal plate; said actuating member is a plastic member covered with a metal guard plate.

11. The package unpacking hand tool as claimed in claim 9 wherein said lever is a metal plate; said actuating member is a plastic member covered with a metal guard plate.

12. The package unpacking hand tool as claimed in claim 2 further comprising a cover plate detachably fastened to said shaft and covered on said receiving space.

13. The package unpacking hand tool as claimed in claim 5 further comprising a cover plate detachably fastened to said shaft and covered on said receiving space.
